(19) United States
(12) Patent Application Publication
(10) Pub. No.: US 2014/0175803 A1
(43) Pub. Date: Jun. 26, 2014

(54) BIOMASS CONVERSION REACTOR POWER GENERATION SYSTEM AND METHOD

(71) Applicant: GENERAL ELECTRIC COMPANY, Schenectady, NY (US)

(72) Inventors: Richard Anthony DePuy, Schenectady, NY (US); Thomas Frederick Leininger, Chino Hills, CA (US); Yichuan Fang, Richmond, TX (US); Ronald Keith Chadwick, Katy, TX (US)

(73) Assignee: GENERAL ELECTRIC COMPANY, Schenectady, NY (US)

(21) Appl. No.: 13/726,930

(22) Filed: Dec. 26, 2012

(51) Int. Cl. F02B 43/08

(52) U.S. Cl. CPC F02B 43/08
USPC 290/1 A

(57) ABSTRACT

Methods and systems for generating power using syngas created using biomass gasification are provided. Exemplary power generation systems include a biomass dryer for receiving biomass, a biomass conversion reactor (either a biomass gasifier or a steam-biomass reformer) for receiving the dried biomass and generating syngas therefrom, and an external combustor for combusting the syngas and heating a working fluid to drive a turbine connected to an electrical generator. The external combustor includes a heat exchanger element for transferring heat from combustion of the syngas into the working fluid, while maintaining the working fluid isolated from the syngas and from syngas combustion products.

### BACKGROUND OF THE INVENTION

The present disclosure relates generally to integrated gasification combined-cycle (IGCC) power generation systems, and more specifically to turbine power generation systems incorporating fuels generated from biomass materials.

At least some known IGCC systems include a gasification system that is integrated with at least one power producing turbine system. Many of these IGCC systems incorporate a gasifier that creates a combustible gas, or a combustible gas precursor, which undergoes further processing into a combustible gas (referred to as “syngas”). Such IGCC systems often further incorporate a gas turbine in which the syngas is combusted and/or which is driven by the combustion byproducts of the burning of the syngas.

A desirable source of syngas or syngas precursor feedstock is biomass material, as the use of biomass material reduces dependency on other sources of syngas feedstock, such as fossil fuel-based feedstocks like coal, coke, etc. However, the use of biomass material as a feedstock for syngas presents challenges for a number of reasons. Syngas produced from biomass material typically is contaminated with tar, ash, particulates or other contaminants, which contaminants are potentially damaging to the internal components of gas turbine engines. Furthermore, in order to be burned in a gas turbine engine, syngas typically must be compressed and/or cooled prior to injection into the gas turbine engine. Compression of the syngas requires expenditure of energy, thus lowering the efficiency of the IGCC system. Cooling of the syngas, typically by water scrubbing, likewise requires expenditure of energy, with a corresponding loss of efficiency.

Accordingly, it would be desirable to provide an IGCC powerplant system and method that uses biomass material as a feedstock for the production of syngas to take advantage of the benefits of deriving power from biomass material, including the reduction in dependency on fossil fuel-based feedstocks. It would also be desirable to provide an IGCC powerplant system and method that is fueled by syngas that has improved efficiency by reducing or eliminating the need for compression or cooling of the syngas.

### BRIEF DESCRIPTION OF THE INVENTION

In one aspect, a power generation system for use in generating power from biomass feedstock is provided. The power generation system includes a biomass conversion reactor coupled to a source of biomass feedstock, the biomass conversion reactor configured to produce syngas. The power generation system also includes a combustor coupled to the biomass conversion reactor. The power generation system also includes a first heat exchanger element coupled in the combustor in flow communication with a source of working fluid that receives heat from combustion of syngas while the working fluid flows through the first heat exchanger element, wherein the working fluid is isolated from the syngas and from products of combustion. The power generation system also includes a turbine coupled in flow communication downstream from the first heat exchanger element, the turbine driven by the heated working fluid.

In another aspect, a method for generating power from biomass feedstock is provided. The method includes channeling biomass feedstock from a source of biomass feedstock to a biomass conversion reactor coupled to the source of biomass feedstock. The method also includes converting the biomass feedstock into syngas. The method also includes channeling the syngas to a combustor coupled to the biomass conversion reactor. The method also includes channeling working fluid from a source of working fluid through a first heat exchanger element coupled in the combustor. The method also includes transferring heat from combustion of the syngas into the working fluid while the working fluid flows through the first heat exchanger element, such that the working fluid is isolated from the syngas and from products of combustion. The method also includes channeling the heated working fluid to a turbine coupled in flow communication downstream from the first heat exchanger element, the turbine driven by the heated working fluid.

### BRIEF DESCRIPTION OF THE DRAWINGS

FIG. 1 is a schematic diagram of an exemplary system for generating power using biomass-generated syngas.

FIG. 2 is a schematic diagram of another exemplary system for generating power using biomass-generated syngas.

FIG. 3 is a schematic diagram of another exemplary system for generating power using biomass-generated syngas.

FIG. 4 is a schematic diagram of another exemplary system for generating power using biomass-generated syngas.

### DETAILED DESCRIPTION OF THE INVENTION

Although specific features of various exemplary embodiments of the invention may be shown in some drawings and not in others, this is for convenience only. In accordance with the principles of the invention, any feature of a drawing may be referenced and/or claimed in combination with any feature of any other drawing.

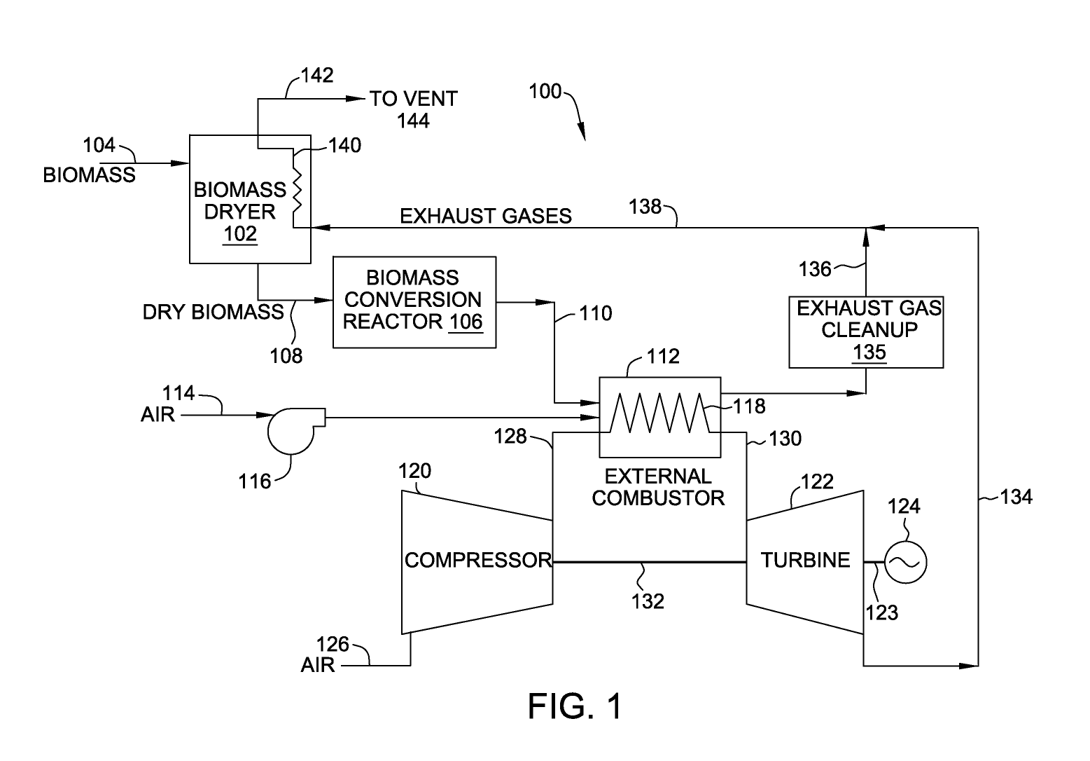

FIG. 1 is a schematic diagram of an exemplary system 100 for generating power using biomass-generated syngas. System 100 includes a biomass dryer 102, which receives biomass from a source 104. A biomass conversion reactor 106 receives dried biomass 108 from biomass dryer 102. Biomass conversion reactor 106 may be any suitable device that may be used to convert biomass into a syngas that will enable the systems described herein to function as described. For example, biomass conversion reactor 106 may be a biomass gasifier or a steam-biomass reformer. Biomass conversion reactor 106 discharges a syngas 110. Syngas 110 is comprised chiefly of hydrogen (H₂), carbon dioxide (CO₂) and carbon monoxide (CO). Syngas 110 is channeled into an external combustor 112, where syngas 110 is combusted with air 114 (typically ambient air) supplied by a blower 116. In an alternative embodiment, a compressor (not shown) may be used in place of blower 116. External combustor 112 discharges an external combustor exhaust 136, which is channeled through an exhaust gas cleanup device 135. External combustor 112 includes a heat exchanger element 118, which is coupled in flow communication with a compressor 120 and a turbine 122. Compressor 120 is rotationally coupled to turbine 122 by a transmission structure 132. System 100 further includes an electrical generator 124, which is rotationally coupled to turbine 122 by a transmission structure 123.

Ambient air 126 is channeled into compressor 120, which discharges a compressed air 128, which is, in turn, channeled into external combustor 112. External combustor 112 discharges a heated compressed air 130, which is channeled to turbine 122, and subsequently discharged from turbine 122 as a turbine exhaust 134. Heated compressed air 130 is expanded in turbine 122, causing rotation of turbine 122, and in turn, rotation of electrical generator 124. Turbine exhaust 134 is combined with external combustor exhaust 136 to supply exhaust gases 138 for biomass dryer 102. After flowing through a heat exchanger 140, cooled gases 142 are then discharged through a vent 144 coupled to biomass dryer 102 to be released to atmosphere, or to be channeled to such additional gas cleaning equipment (not shown) as may be required.

In system 100, syngas 110 and external combustor exhaust 136 are isolated from compressor 120 and turbine 122. Accordingly, compressor 120 and turbine 122 are protected from the damaging effects of tar, ash and other particulates, and other contaminants found in biomass-generated syngas and the combustion products therefrom. In addition, biomass-generated syngas 110 is channeled to external combustor 112, without the requirement for any specific provisions for cooling or contaminant removal.

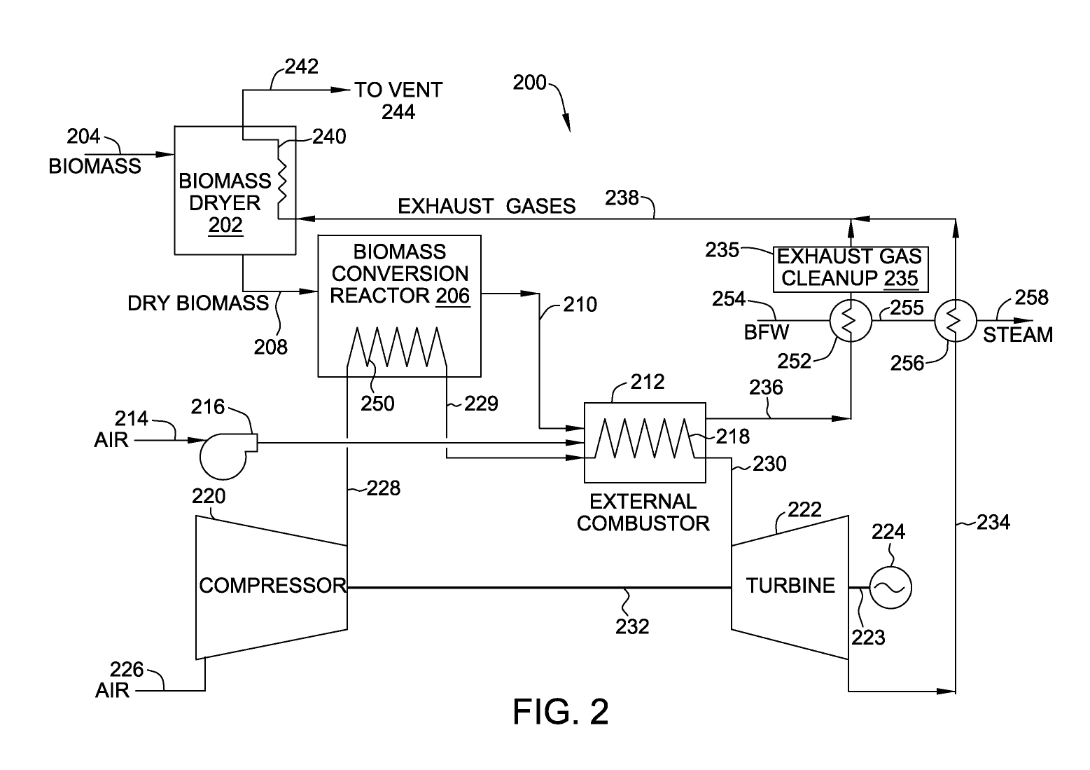

FIG. 2 is a schematic diagram of an alternative exemplary system 200 for generating power using biomass-generated syngas. System 200 includes a biomass dryer 202, which receives biomass from a source 204. A biomass conversion reactor 206 receives dried biomass 208 from biomass dryer 202 and discharges a syngas 210. Biomass conversion reactor 206 also includes a heat exchanger element 250, which is coupled in flow communication with a compressor 220 and with a turbine 222. Syngas 210 is channeled into an external combustor 212, where syngas 210 is combusted with air 214 (typically ambient air) supplied by a blower 216. In an alternative embodiment, a compressor (not shown) may be used in place of blower 216. External combustor 212 discharges an external combustor exhaust 236. External combustor 212 includes a heat exchanger element 218, which is coupled in flow communication with compressor 220, heat exchanger element 250, and turbine 222. Compressor 220 is rotationally coupled to turbine 222 by a transmission structure 232. An electrical generator 224 is rotationally coupled to turbine 222 by a transmission structure 223.

Ambient air 226 is channeled into compressor 220, which discharges a compressed air 228, which in turn is channeled into biomass conversion reactor 206. Specifically, compressed air 228 is channeled through heat exchanger element 250 in the biomass conversion reactor 206, acquiring heat released during the gasification process. Biomass conversion reactor 206 discharges a heated compressed air 229, which is channeled to external combustor 212, where heated compressed air 229 acquires further heat while flowing through heat exchanger element 218.

Heat from the combustion of syngas 210 is transferred to heated compressed air 229, resulting in a further heated compressed air 230. Further heated compressed air 230 is channeled to turbine 222 and expanded, causing rotation of turbine 222, and in turn, rotation of electrical generator 224. Turbine 222 discharges a turbine exhaust 234. External combustor 212 is coupled in flow communication with heat exchanger 252. External combustor exhaust 236 is channeled to heat exchanger 252 to release heat to a boiler feed water 254, creating a heated boiler feed water 255. External combustor exhaust 236 is then channeled to an exhaust gas cleanup device 235. Heated boiler feed water 255 is channeled to a heat exchanger 256 coupled in flow communication with turbine 222, where heated boiler feed water 255 acquires further heat from turbine exhaust 234, and is converted into a steam 258. Steam 258, in turn, is then channeled to a steam turbine (not shown) to generate further electrical or mechanical power, or is exported for other purposes. Turbine exhaust 234 and external combustor exhaust 236 are combined to supply exhaust gases 238, which are channeled through a heat exchanger 240 coupled to biomass dryer 202. Afterward, cooled gases 242 are discharged through a vent 244 coupled to biomass dryer 202 to be released to atmosphere.

Similarly to system 100 described herein, in system 200, syngas 210 and external combustor exhaust 236 are isolated from compressor 220 and turbine 222. Accordingly, compressor 220 and turbine 222 are protected from the damaging effects of tar, ash and other particulates, and other contaminants found in biomass-generated syngas and the combustion products therefrom. In addition, biomass-generated syngas 210 is channeled to external combustor 212, without the requirement for any specific provisions for cooling or contaminant removal.

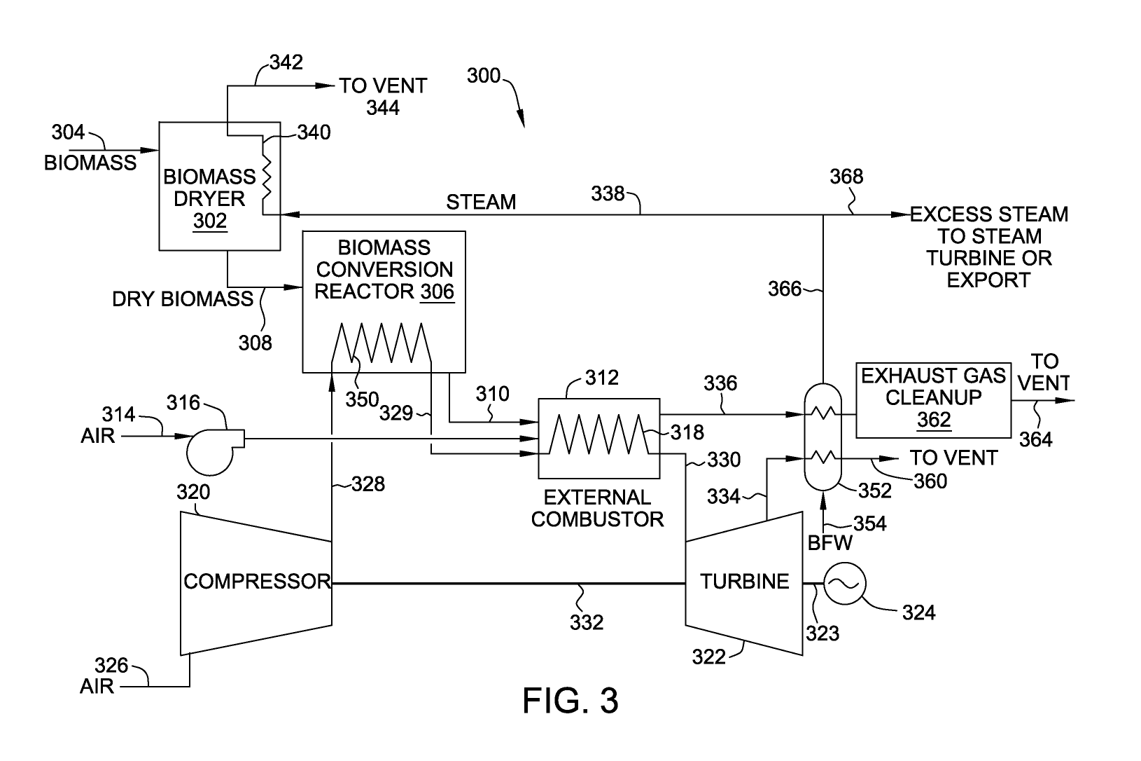

FIG. 3 is a schematic diagram of another alternative exemplary system 300 for generating power using biomass-generated syngas. System 300 includes a biomass dryer 302, which receives biomass from a source 304. A biomass conversion reactor 306 receives dried biomass 308 from biomass dryer 302, and discharges a syngas 310. Biomass conversion reactor 306 also includes a heat exchanger element 350, which is coupled in flow communication with a compressor 320 and with a turbine 322. Syngas 310 is channeled into an external combustor 312, where syngas 310 is combusted with air 314 (typically ambient air) supplied by a blower 316. In an alternative embodiment, a compressor (not shown) may be used in place of blower 316. External combustor 312 includes a heat exchanger element 318 coupled in flow communication with compressor 320 and turbine 322. External combustor 312 discharges an external combustor exhaust 336. Compressor 320 is rotationally coupled to turbine 322 by a transmission structure 332. An electrical generator 324 is rotationally coupled to turbine 322 by a transmission structure 323.

Ambient air 326 is channeled into the compressor 320, which discharges a compressed air 328, which in turn is channeled into biomass conversion reactor 306. Specifically, compressed air 328 is channeled through heat exchanger element 350, acquiring heat released during the gasification process. Biomass conversion reactor 306 discharges a heated compressed air 329, which is channeled to external combustor 312, where heated compressed air 329 acquires further heat while flowing through heat exchanger element 318. A resulting further heated compressed air 330 is channeled to turbine 322 and expanded, causing rotation of turbine 322, and in turn, rotation of electrical generator 324. Turbine 322 discharges a turbine exhaust 334.

External combustor 312 is coupled in flow communication with a heat exchanger 352, which is also coupled in flow communication with turbine 322 to receive turbine exhaust 334. External combustor exhaust 336 is channeled to heat exchanger 352, wherein external combustor exhaust 336 transfers heat to a boiler feed water 354. Turbine exhaust 334 also releases heat to boiler feed water 354 while flowing through heat exchanger 352. Turbine exhaust 334, being essentially only heated air, is channeled through a vent 360 to atmosphere. External combustor exhaust 336 is channeled through an exhaust gas cleanup apparatus 362, for removal of particulates and other contaminants. Cleaned external combustor exhaust 336 is then channeled to a vent 364 to be released to atmosphere. Boiler feed water 354, having flowed through heat exchanger 352, is converted to a steam 366. A portion 338 of steam 366 is channeled to biomass dryer 302 for use in drying the biomass feedstock. Another portion 368 of steam 366 is channeled to a steam turbine (not shown) for the generation of additional electrical or mechanical power, or otherwise exported to other locations where a supply of steam is needed. Steam portion 338 is channeled through a heat exchanger element 340 coupled to biomass dryer 302. Cooled steam 342 is subsequently channeled to a vent 344 to be released to atmosphere or to be channeled to other equipment (not shown).

Similarly to systems 100 and 200 described herein, in system 300, syngas 310 and external combustor exhaust 336 are isolated from compressor 320 and turbine 322. Accordingly, compressor 320 and turbine 322 are protected from the damaging effects of tar, ash and other particulates, and other contaminants found in biomass generated syngas, and the combustion products therefrom.

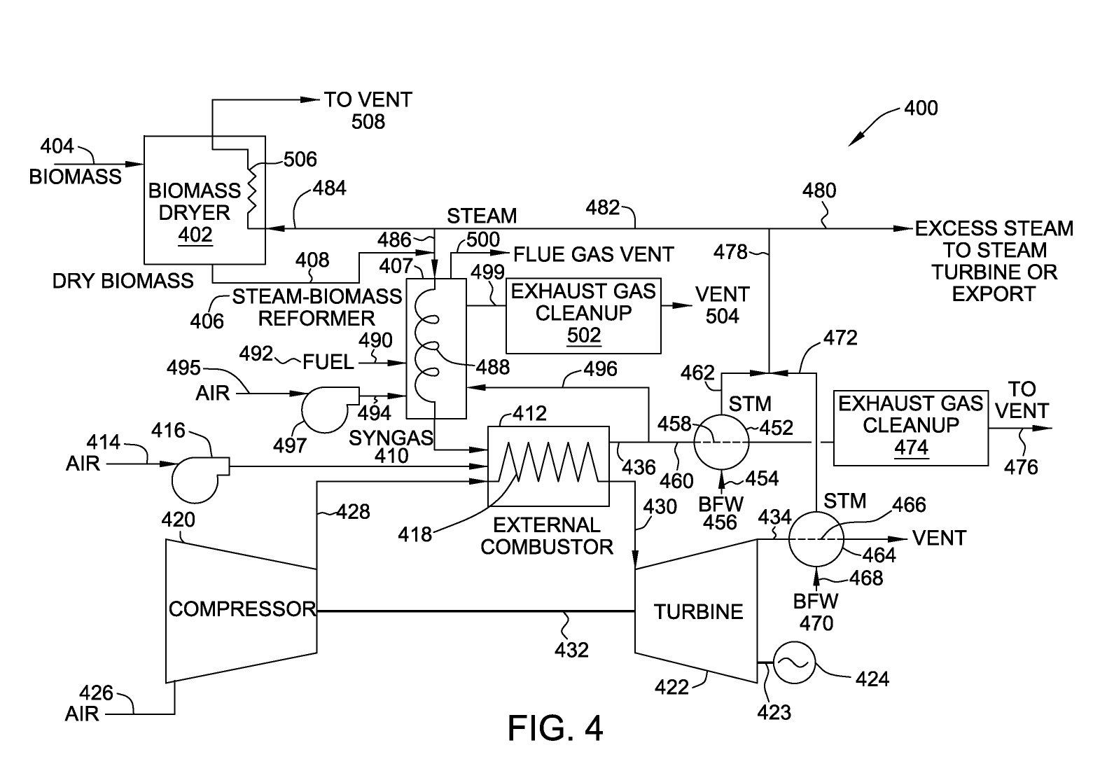

FIG. 4 is a schematic diagram of another alternative exemplary system 400 for generating power using biomass-generated syngas. System 400 includes a biomass dryer 402, which receives biomass from a source 404. A biomass conversion reactor 406 receives dried biomass 408 from biomass dryer 402, and discharges a syngas 410. In the exemplary embodiment, biomass conversion reactor 406 is a steam-biomass reformer, and includes a shell 407 and a heat-exchanging coil 488 that extends through biomass conversion reactor 406, through which biomass 408 is channeled. Syngas 410 is channeled into an external combustor 412, where syngas 410 is combusted with air 414 (typically ambient air) supplied by a blower 416. In an alternative embodiment, a compressor (not shown) may be used in place of blower 416. The external combustor 412 includes a heat exchanger element 418 coupled in flow communication with a compressor 420 and a turbine 422. External combustor 412 discharges an external combustor exhaust 436. Compressor 420 is rotationally coupled to turbine 422 by a transmission structure 432. An electrical generator 424 is rotationally coupled to turbine 422 by a transmission structure 423.

Ambient air 426 is channeled into compressor 420, which discharges a compressed air 428, which in turn is channeled into external combustor 412, where compressed air 428 acquires heat while flowing through heat exchanger element 418. A resulting heated compressed air 430 is channeled to turbine 422 and expanded, causing rotation of turbine 422, and in turn, rotation of electrical generator 424. Turbine 422 discharges a turbine exhaust 434.

In the exemplary embodiment, a portion 496 of external combustor exhaust 436 is channeled to biomass conversion reactor 406 to supply heat for a steam-biomass reformation reaction. Portion 496 may supply all heat requirements for biomass conversion reactor 406. In an alternative embodiment, portion 496 may supply only part of the heat requirement of biomass conversion reactor 406. In such a situation, a fuel 490 from a source 492 and an air 494 from a source 495 are channeled via blower 497 into shell 407 and combusted to supply the remainder of the heat requirement. In another alternative embodiment, a compressor (now shown) may be used in place of blower 497. In another alternative embodiment, combustion of fuel 490 and air 494 provides all of the heat required by biomass conversion reactor 406, and none of external combustor exhaust 436 is diverted to biomass conversion reactor 406. In an embodiment in which external combustor exhaust 436 is not used to provide heat for biomass conversion reactor 406, combustion products from the combustion of fuel 490 and air 494 are vented 500 as flue gas. In an embodiment in which portion 496 of external combustor exhaust 436 is used to provide heat to biomass conversion reactor 406, cooled portion 499 is channeled through exhaust gas cleanup device 502 prior to being vented 504 to atmosphere, to ensure that syngas contaminants are removed prior to release to atmosphere. If a combination of external combustion exhaust gas portion 496 and combustion of additional fuel 490 and air 494 are used to supply heat to biomass conversion reactor 406, the combustion of additional fuel 490 and air 494 acts as a second combustion stage for portion 496, facilitating complete combustion of syngas contaminants present in portion 496.

In the exemplary embodiment, external combustor 412 is coupled in flow communication with a heat exchanger 452. A boiler feed water 454 from a source 456 of boiler feed water is channeled to heat exchanger 452. If portion 496 amounts to less than all of external combustor exhaust 436, a portion 460 of external combustor exhaust 436 is channeled to heat exchanger 452, through heat exchanger element 458, wherein portion 460 transfers heat to boiler feed water 454 to produce a steam 462. Turbine exhaust 434 is channeled to a heat exchanger 464, through a heat exchanger element 466. A boiler feed water 468 from a source 470 is channeled through heat exchanger 464, such that heat from turbine exhaust 434 is transferred to boiler feed water 468 to produce a steam 472. Steams 462 and 472 are combined to form steam flow 478.

A portion 480 of steam flow 478 may be used as excess export steam. Another portion 482 of steam flow 478 is supplied to biomass dryer 402 as steam portion 484, and to biomass conversion reactor 406 as steam portion 486. In the exemplary embodiment, steam portion 482 may be superheated steam. In alternative embodiments, other types of steam may be present in steam portion 482. Steam portion 484 is channeled through heat exchanger element 506, to transfer heat to biomass 408, after which steam portion 484 is vented 508 to atmosphere. Steam portion 486 is mixed with biomass 408 and channeled through a coil (or other heat-exchanging conduit) 488, coupled through biomass conversion reactor 406, towards channeling syngas 410 to external combustor 412. Heat generated from the combustion of fuel 490 and air 494, and from the heat contained within a portion 496 of external combustor exhaust 436, if present, is transferred into biomass 408 and steam portion 486 flowing through coil 488.

Similarly to systems 100, 200, and 300 described herein, in system 400, syngas 410 and external combustor exhaust 436 are isolated from compressor 420 and turbine 422. Accordingly, compressor 420 and turbine 422 are protected from the damaging effects of tar, ash and other particulates, and other contaminants found in biomass generated syngas, and the combustion products therefrom.

In contrast to known integrated gasification combined-cycle (IGCC) power generation systems, the biomass conversion reactor power generation systems described herein enable biomass-generated syngas to be used for generating power, while protecting sensitive compressor and/or turbine components from the potentially destructive effects associated with syngas generated from biomass materials. This is accomplished by segregating the flow path of the biomass-generated syngas from the flow path of the working fluid used in the compressor and turbine. In addition, the biomass conversion reactor power generation system as described herein eliminates the need for cooling and/or compressing the syngas, which measures are required when syngas is combusted and the syngas combustion products are added directly to the working fluid in a compressor and turbine, as in combustion turbine applications.

Exemplary embodiments of a method and a system for generating power using biomass-generated syngas are described above in detail. The method and system are not limited to the specific embodiments described herein, but rather, components of systems and/or steps of the methods may be utilized independently and separately from other components and/or steps described herein. For example, the methods and systems described herein may also be used in combination with other power generation schemes, and are not limited to practice with only the components as described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention has been described in terms of various specific embodiments, those skilled in the art will recognize that the invention can be practiced with modification within the spirit and scope of the claims.

What is claimed is:

1. A power generation system for use in generating power from biomass feedstock, said power generation system comprising:
a biomass conversion reactor coupled to a source of biomass feedstock, said biomass conversion reactor configured to produce syngas;
a combustor coupled to said biomass conversion reactor;
a first heat exchanger element coupled in said combustor in flow communication with a source of working fluid that receives heat from combustion of syngas while the working fluid flows through said first heat exchanger element, wherein said working fluid is isolated from the syngas and from products of combustion; and
a turbine coupled in flow communication downstream from said first heat exchanger element, the turbine driven by the heated working fluid.

2. A power generation system in accordance with claim 1, further comprising a blower coupled in flow communication with a source of combustion air and with said combustor.

3. A power generation system in accordance with claim 1, further comprising a biomass dryer coupled in flow communication with said source of biomass feedstock and with said biomass conversion reactor.

4. A power generation system in accordance with claim 3, further comprising a second heat exchanger element located in said biomass dryer, said second heat exchanger element is coupled in flow communication with at least one of said combustor and said turbine.

5. A power generation system in accordance with claim 1, further comprising a compressor coupled in flow communication with said first heat exchanger element and with said turbine.

6. A power generation system in accordance with claim 5, further comprising a second heat exchanger element coupled in said biomass conversion reactor, said second heat exchanger element coupled in flow communication with said compressor and with said first heat exchanger element.

7. A power generation system in accordance with claim 1, further comprising at least one heat exchanger coupled to a source of boiler feed water and with at least one of said combustor and said turbine.

8. A power generation system in accordance with claim 7, wherein said at least one heat exchanger comprises:
a first heat exchanger coupled in flow communication with said combustor; and
a second heat exchanger coupled in flow communication with said turbine.

9. A power generation system in accordance with claim 1, further comprising an electrical generator rotationally coupled to said turbine.

10. A power generation system in accordance with claim 1, further comprising a portion of an exhaust discharged from said combustor channeled to said biomass conversion reactor to supply heat to said biomass conversion reactor.

11. A method for generating power from biomass feedstock, said method comprising:
channeling biomass feedstock from a source of biomass feedstock to a biomass conversion reactor coupled to the source of biomass feedstock;
converting the biomass feedstock into syngas;
channeling the syngas to a combustor coupled to the biomass conversion reactor;
channeling working fluid from a source of working fluid through a first heat exchanger element coupled in the combustor;
transferring heat from combustion of the syngas into the working fluid while the working fluid flows through the first heat exchanger element, such that the working fluid is isolated from the syngas and from products of combustion; and
channeling the heated working fluid to a turbine coupled in flow communication downstream from the first heat exchanger element, the turbine driven by the heated working fluid.

12. A method in accordance with claim 11, said method further comprising channeling combustion air from a source of combustion air through a blower coupled in flow communication with the combustor.

13. A method in accordance with claim 11, said method further comprising channeling the biomass feedstock through a biomass dryer coupled in flow communication with the source of biomass feedstock and with the biomass conversion reactor.

14. A method in accordance with claim 13, said method further comprising channeling an exhaust from at least one of the combustor and the turbine through a second heat exchanger element located in the biomass dryer, the second heat exchanger element coupled in flow communication with at least one of the combustor and the turbine.

15. A method in accordance with claim 13, said method further comprising channeling the working fluid through a compressor coupled in flow communication with the first heat exchanger element and with the turbine.

16. A method in accordance with claim 15, said method further comprising channeling the working fluid through a second heat exchanger element coupled in the biomass conversion reactor, the second heat exchanger element coupled in flow communication with the compressor and with the first heat exchanger element.

17. A method in accordance with claim 11, said method further comprising:
channeling boiler feed water from a source of boiler feed water through at least one heat exchanger coupled in flow communication with at least one of the combustor and the turbine.

18. A method in accordance with claim 17, wherein the at least one heat exchanger comprises:
a first heat exchanger coupled in flow communication with the combustor; and
a second heat exchanger coupled in flow communication with the turbine.

19. A method in accordance with claim 1, said method further comprising driving an electrical generator rotationally coupled to the turbine.

20. A method in accordance with claim 11, said method further comprising channeling a portion of an exhaust discharged from said combustor to said biomass conversion reactor to supply heat to said biomass conversion reactor.
